(19) United States
(12) Patent Application Publication
(10) Pub. No.: US 2015/0166000 A1
(43) Pub. Date: Jun. 18, 2015

(54) SEAT OCCUPANCY DETERMINATION DEVICE

(71) Applicant: Aisin Seiki Kabushiki Kaisha, Kariya-shi (JP)

(72) Inventors: Isao HONDA, Chiryu-shi (JP); Yoshiaki Tomatsu, Toyoake-shi (JP); Yusuke Takahashi, Toyota-shi (JP); Tomomi Tomizawa, Nisshin-shi (JP)

(73) Assignee: Aisin Seiki Kabushiki Kaisha, Kariya-shi (JP)

(21) Appl. No.: 14/551,195

(22) Filed: Nov. 24, 2014

(30) Foreign Application Priority Data
Dec. 13, 2013 (JP) 2013-257702

(51) Int. Cl. B60R 21/16; B60R 22/48

(52) U.S. Cl. CPC B60R 21/16; B60R 22/48; B60R 2021/162; B60R 2022/4858; B60R 2022/1812

(57) ABSTRACT

A seat occupancy determination device includes first and second load sensors, a seatbelt attachment detection device, a vehicle motion determination portion, and a seat occupancy determination logic portion configured to determine a state of a vehicle seat whether the vehicle seat is in a child-safety-seat fixed state, in an adult-passenger seated state, and in a no passenger state; the seat occupancy determination logic portion including a stopped-state seat occupancy determination logic portion and a motion-state seat occupancy determination logic portion each being set with an availability of transition from a first state to a second state of the three states and the transition conditions from the first state to a second state of the three states individually in order to transition a determination of the state of the vehicle seat precisely when the vehicle is in the stopped state and when the vehicle is in motion, respectively.

### CROSS REFERENCE TO RELATED APPLICATIONS

This application is based on and claims priority under 35 U.S.C. §119 to Japanese Patent Application 2013-257702, filed on Dec. 13, 2013, the entire content of which is incorporated herein by reference.

### TECHNICAL FIELD

This disclosure generally relates to a seat occupancy determination device.

### BACKGROUND DISCUSSION

In order to enhance performances of various safety devices, for example, airbags and seatbelts mounted to a vehicle, operations of the safety devices are controlled in accordance with a weight of an occupant that is seated in a seat according to known apparatuses. For example, when the occupant is seated in the seat without wearing a seatbelt, an alarm indicates that the seatbelt is unbuckled. Further, the law stipulates that a passenger-side airbag is to be deployed at a vehicle collision when an adult is seated in a passenger seat. The law further stipulates that a deployment of an airbag should be prohibited in a case where a child safety seat is fixed to the passenger seat facing backward, or a rear of the vehicle so that an infant or a child and a driver can see each other because an impact by the deployment of the airbag causes adverse effects. Under the law, a weight of a smaller female adult is applied as a criterion for determining whether an occupant is an adult. The law also stipulates a criterion for determining an infant or a child. Thus, detecting a load applied to the seat to obtain a correct determination of a seat load, an occupancy state, or types of occupants is important to ensure a safety of the occupant.

An example of a passenger detection device distinguishing an existence and nonexistence of a passenger by detecting a load applied to a seat is disclosed in JPH09-207638A (hereinafter referred to as Patent reference 1). The passenger detection device includes load sensors provided only at two of plural seat attachment portions and distinguishes the existence and nonexistence of a passenger on the basis of a sum total of the two obtained load values. That is, the load sensors are provided at two minimum positions of the seat attachment portions which are usually provided at four positions so that the passenger detection device is available with a simple and inexpensive configuration.

Another example of a passenger detection device determining whether a seat is occupied by an adult passenger or by a child safety seat fixed to the seat is disclosed in JP2013-001152A (hereinafter referred to as Patent reference 2). The seat occupancy determination device includes two load sensors which are placed at a front and a rear of one of a right side and a left side of the seat, detects a load applied to the seat, and determines whether the seat is occupied by an adult passenger or by a child safety seat fixed to the seat. However, for example, a centrifugal force is applied to the seat and a load applying body on the seat when a vehicle is in a turning movement. In those circumstances, normally, the load of the seat and the load of the load applying body on the seat cannot be detected precisely only by two load sensors. Accordingly, the seat occupancy determination device disclosed in Patent reference 2 is constructed to determine that the vehicle is in the turning movement by a lateral acceleration detected by a gravity sensor mounted on the vehicle. When it is determined that the vehicle is in the turning movement, the determination of the load applying body on the seat in response to a load value outputted by the two load sensors is stopped to prevent wrong determination.

However, the passenger detection device disclosed in Patent reference 1 is provided with the minimum installation of the load sensors for cost and weight reduction measures. Thus, even if the passenger detection device can distinguish the existence or the nonexistence of a passenger, the passenger detection device may not be able to determine whether the seat is occupied by an adult passenger or by the child safety seat. For example, as explained in Patent reference 2, in a case where the vehicle is in the turning movement, the passenger detection device may not be able to detect the load on the seat precisely and may lead to wrong determination between an adult passenger and the child safety seat.

On the other hand, according to the seat occupancy determination device disclosed in Patent reference 2, in a case where the vehicle is in the turning movement, the seat occupancy determination device stops determining the load on the seat so that the wrong determination may not be occurred. However, the seat occupancy determination device disclosed in Patent reference 2 cannot perform the determination of the load on the seat when the vehicle is in the turning movement, which may raise a question in terms of continuous and precise determination of the load on the seat.

A need thus exists for a seat occupancy determination device which is not susceptible to the drawback mentioned above.

### SUMMARY

According to an aspect of this disclosure, a seat occupancy determination device includes a first load sensor configured to be placed at a bottom front portion of one of sides of a vehicle seat in a vehicle width direction, the first load sensor detecting a part of a load applied to the vehicle seat, a second load sensor configured to be placed at a bottom rear portion of the one of the sides of the vehicle seat, the one of the sides where the first load sensor is placed, the second load sensor placed to be spaced apart from the first load sensor, the second load sensor detecting a part of the load applied to the vehicle seat, a seatbelt attachment detection device configured to detect an engagement and disengagement of a tongue plate and a buckle of a seatbelt, a total load value calculation portion calculating a total load value of a first load value detected by the first load sensor and a second load value detected by the second load sensor, a vehicle motion determination portion configured to determine whether a vehicle is in a stopped state or in motion in response to a vehicle speed detected by a vehicle speed detection portion, and a seat occupancy determination logic portion configured to determine a state of the vehicle seat whether the vehicle seat is in a child-safety-seat fixed state which is a state where a child safety seat is fixed on the vehicle seat, in an adult-passenger seated state which is a state where an adult passenger is seated in the vehicle seat, and in a no passenger state which is a state where no passenger is seated, or an infant or a child is seated in the vehicle seat, the seat occupancy determination logic portion transitioning a determination of a current state of the vehicle seat from a first state to a second state of three states which are the child-safety-seat fixed state, the adult-passenger seated state, and the no passenger state on the basis of a satisfaction and dissatisfaction of a preset transition condition from the first state to the second state, the seat occupancy determination logic portion including a stopped-state seat occupancy determination logic portion being set with an availability of transition from the first state to the second state of the three states and the transition conditions from the first state to the second state of the three states individually in order to transition the determination of the state of the vehicle seat precisely between the three states which are the child-safety-seat fixed state, the adult-passenger seated state, and the no passenger state when the vehicle is in the stopped state, a motion-state seat occupancy determination logic portion being set with the availability of transition from the first state to the second state of the three states and the transition conditions from the first state to the second state of the three states individually in order to transition the determination of the state of the vehicle seat precisely between the three states which are the child-safety-seat fixed state, the adult-passenger seated state, and the no passenger state when the vehicle is in motion, and a logic selection portion selecting the stopped-state seat occupancy determination logic portion when the vehicle is in the stopped state, the logic selection portion selecting the motion-state seat occupancy determination logic portion when the vehicle is in motion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an explanatory view schematically showing a seat occupancy determination device mounted to a vehicle according to an embodiment disclosed here;

FIG. 2 is a block diagram explaining a construction of the seat occupancy determination device according to the embodiment;

FIG. 3 is a transition diagram simply showing a relationship between each of states which is transitioned by a stopped-state seat occupancy determination logic portion which corresponds to a seat occupancy determination logic portion when a vehicle is in a stopped state;

FIG. 4 is a transition diagram simply showing a relationship between each of states which is transitioned by a motion-state seat occupancy determination logic portion which corresponds to a seat occupancy determination logic portion when the vehicle is in motion;

FIG. 5 is a transition diagram simply showing a relationship between each of states which is transitioned by a turning-movement-state seat occupancy determination logic portion which corresponds to a seat occupancy determination logic portion when the vehicle is in a turning movement; and

FIG. 6 is a flowchart of the seat occupancy determination logic portion.

### DETAILED DESCRIPTION

An embodiment of a seat occupancy determination device 1 determining whether an adult passenger is seated in a vehicle seat, whether a child safety seat is fixed to the seat, or whether the seat is unoccupied or is occupied by an infant or a child will be explained with reference to the drawings.

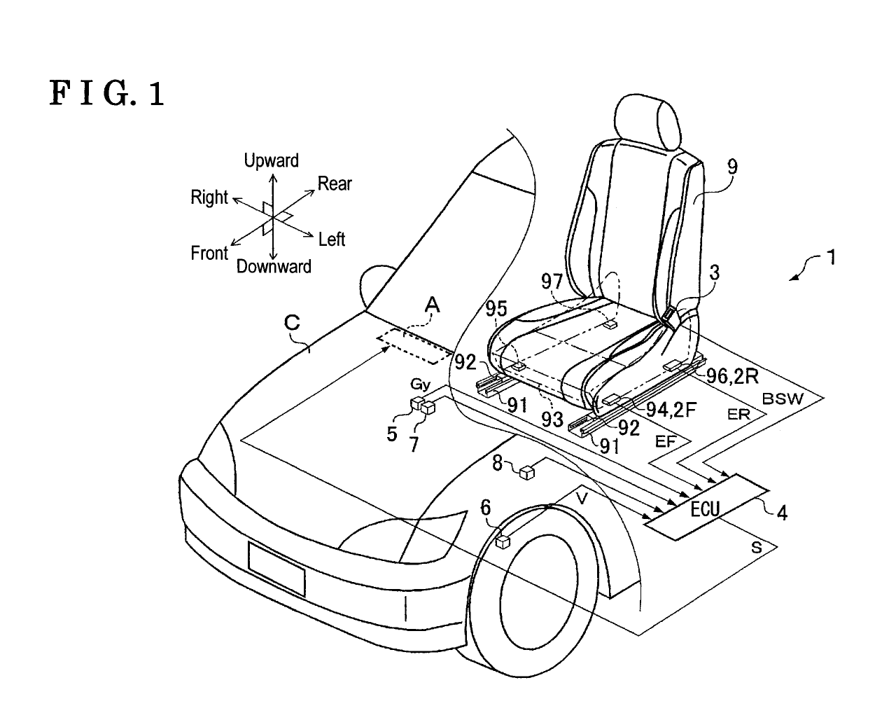

A construction of the seat occupancy determination device 1 will be explained as follows. A left-hand drive vehicle is, for example, applied as a vehicle C shown in FIG. 1. FIG. 1 is a perspective view viewing the vehicle C from obliquely above for an explanatory purpose, and a roof portion of the vehicle C is cut away for showing a seat 9 (i.e., serving as a vehicle seat) for a passenger which is an object for a seat load determination by the seat occupancy determination device 1. A driver's seat is not shown in FIG. 1. The seat occupancy determination device 1 performs a seat occupancy determination, for example, an occupant seated in the seat 9, and a seat occupancy state. A deployment of an airbag A built-in a dashboard provided facing a passenger seat is controlled on the basis of a result of the determination. According to the embodiments, upward, downward, left, right, front, rear corresponds to upward, downward, left, right, front, rear indicated in FIG. 1.

The seat 9 is configured to move in a front-rear direction by a slide mechanism which includes a right-left pair of lower rails 91 and upper rails 92 extending in the front-rear direction of the vehicle C. A lower portion frame 93 which is covered with a cushion of the seat 9 is supported by the upper rails 92 via support portions 94, 95, 96, 97 located at four corners of a bottom surface of the lower portion frame 93, respectively.

As shown in FIG. 1, the vehicle C includes an electronic control unit 4, or an ECU 4 provided either in an engine compartment or a vehicle compartment. A first load sensor 2F and a second load sensor 2R provided at the seat 9 and a buckle switch 3 (i.e., serving as a seatbelt attachment detection device) are connected to the ECU 4. Further, a gravity sensor (i.e., serving as a lateral acceleration detection portion) 5 or a G sensor 5, a vehicle speed sensor 6 (i.e., serving as a vehicle speed detection portion and an acceleration sensor), a yaw rate sensor 7, and a steering angle sensor 8 are connected to the ECU 4.

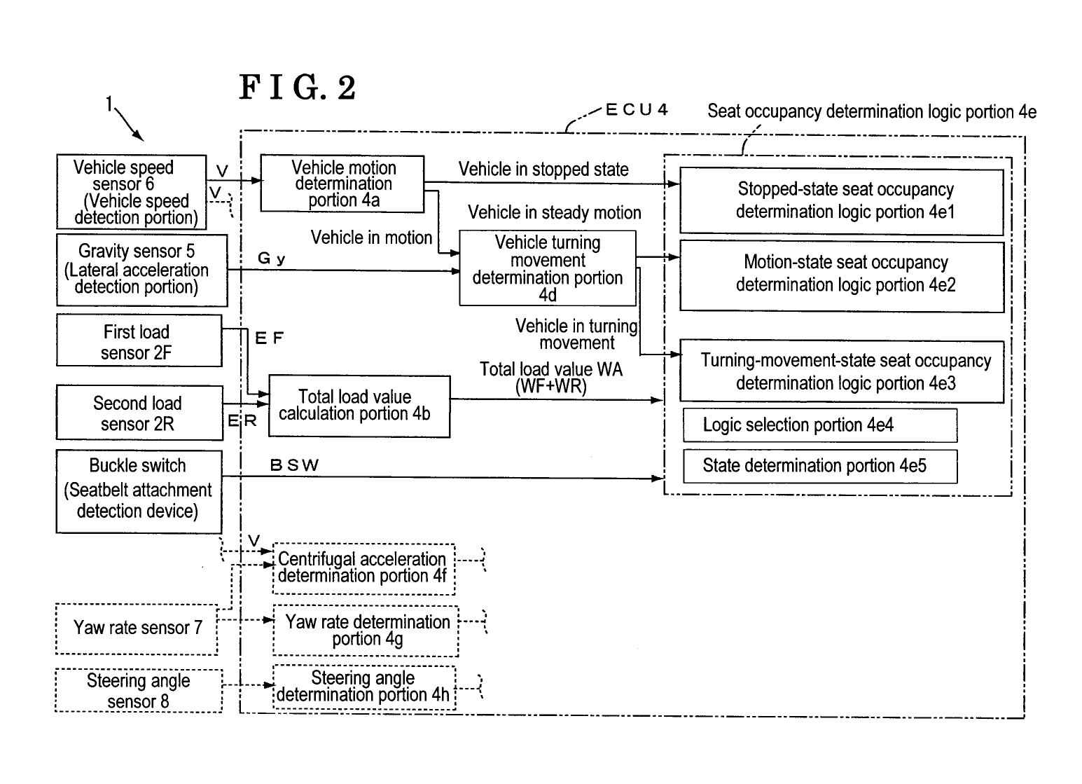

As shown in FIG. 2, the ECU 4 includes a vehicle motion determination portion 4a, a total load value calculation portion 4b, a vehicle-turning-movement determination portion 4d, a seat occupancy determination logic portion 4e, a centrifugal acceleration determination portion 4f, a yaw rate determination portion 4g, and a steering angle determination portion 4h. The seat occupancy determination logic portion 4e is provided with a logic selection portion 4e4, a stopped-state seat occupancy determination logic portion 4e1, a motion-state seat occupancy determination logic portion 4e2, a turning-movement-state seat occupancy determination logic portion 4e3, and a state determination portion 4e5. The stopped-state seat occupancy determination logic portion 4e1 corresponds to a seat occupancy determination logic portion when the vehicle C is in the stopped state. The motion-state seat occupancy determination logic portion 4e2 corresponds to a seat occupancy determination logic portion when the vehicle C is in motion. The turning-movement-state seat occupancy determination logic portion 4e3 corresponds to a seat occupancy determination logic portion when the vehicle C is in a turning movement.

According to the embodiment, the seat occupancy determination device 1 is structured with the first and second load sensors 2F, 2R, the buckle switch 3, the G sensor 5, and the vehicle speed sensor 6. The seat occupancy determination device 1 is further structured with the vehicle motion determination portion 4a, the total load value calculation portion 4b, the vehicle-turning-movement determination portion 4d, and the seat occupancy determination logic portion 4e provided in the ECU 4.

The ECU 4 includes a calculation portion, a memory portion, an input portion, and an output portion and is operated by software. The vehicle motion determination portion 4a, the total load value calculation portion 4b, the vehicle-turning-movement determination portion 4d, and the seat occupancy determination logic portion 4e provided in the ECU 4 are activated mainly with software.

The first load sensor 2F is provided at a support portion 94 placed at a front-left of the seat 9 and the second load sensor 2R is provided at a support portion 96 placed at a rear-left of the seat 9. That is, the first and second load sensors 2F, 2R are placed to be spaced apart from each other at a bottom front portion and a bottom rear portion of the left side of the seat 9 and detect a part of the load applied to the seat 9, respectively. Two support portions 95, 97 placed to be spaced apart from each other at the front and rear of the right side of the seat 9 are constructed to simply support the load. The first and second sensors 2F, 2R are strain gauge type sensors. Electric outputs EF, ER outputted from the respective first and second load sensors 2F, 2R are inputted into the total load value calculation portion 4b of the ECU 4.

The buckle switch 3 for detecting whether an occupant wears a seatbelt is placed within a buckle provided at the seat 9. The buckle switch 3 is turned on when a tongue plate of the seatbelt engages with the buckle. The buckle switch 3 is turned off when the tongue plate of the seatbelt disengages from the buckle. Buckle information BSW outputted from the buckle switch 3 by turning thereon is inputted into the seat occupancy determination logic portion 4e of the ECU 4. The circuit of the buckle switch 3 may be constructed such that the signal is not outputted in a state where the buckle switch 3 is disengaged (OFF), or that the signal is outputted in a state where the buckle switch 3 is disengaged.

The G sensor 5 is an acceleration sensor for detecting the acceleration acting on the vehicle C, and is configured to detect accelerations Gx, Gy, Gz in three directions X, Y, Z. The G sensor 5 is mounted to the vehicle C close to the center of the gravitation of the vehicle C in a state where the X direction is oriented in a front-rear direction of the vehicle C, the Y direction is oriented in a vehicle width direction of the vehicle C, and the Z direction is oriented in an upward-downward direction of the vehicle C. The acceleration Gy directed in the Y direction corresponds to the lateral acceleration acting on the vehicle C. The lateral acceleration Gy includes the all lateral accelerations acting on the vehicle C due to the inclination, or the tilt of the vehicle body and the centrifugal force applied to the vehicle C irrespective of states of the vehicle C whether the vehicle C is in motion or in a stopped state. The lateral acceleration Gy is inputted to the vehicle-turning-movement determination portion 4d of the ECU 4.

The vehicle speed sensor 6 is provided at each of right and left wheels of the vehicle C, and is configured to detect a vehicle speed V by detecting a rotational state of the wheels. The vehicle speed V is inputted into the vehicle motion determination portion 4a of the load determination ECU 4.

The vehicle motion determination portion 4a is an operation portion determining whether the vehicle C is in motion or in the stopped state on the basis of the vehicle speed V outputted from the vehicle speed sensor 6. According to the embodiment, the vehicle motion determination portion 4a determines that the vehicle C is in the stopped state in a case where the vehicle speed V is equal to or lower than a low vehicle speed Vmin which corresponds to several kilometers per hour, for example, from 3 to 10 kilometers per hour. Accordingly, the vehicle motion determination portion 4a determines that the vehicle C is in motion in a case where the vehicle speed V exceeds the low vehicle speed Vmin.

Methods for determining whether the vehicle C is in motion or is in the stopped state are not limited to the aforementioned method. For example, whether the vehicle C is in motion or is in the stopped state may be determined on the basis of a change of the acceleration in the front-rear direction of the vehicle C detected by the G sensor 5. Alternatively, whether the vehicle C is in motion or is in the stopped state may be determined on the basis of a detected signal transmitted from the acceleration sensor 5. As described above, the vehicle speed V may be obtained by any methods.

The total load value calculation portion 4b provided at the input portion of the ECU 4 includes an analog-to-digital converter (A/D converter), and is configured to obtain a load value WF (i.e., serving as a first load value) (newton or kilogram weight) at the front-left and a load value WR (i.e., serving as a second load value) (newton or kilogram weight) at the rear-left from the electric outputs EF, ER of the first and second load sensors 2F, 2R applying a predetermined conversion equation. Then, a total load value WA which is the sum of load values WF, WR is calculated and outputted by the total load value calculation portion 4b. In those circumstances, the total load value calculation portion 4b is activated at a predetermined sampling cycle, and performs a moving average in which the most recent plural raw data is equalized to output the total load value WA.

Here, pre-performed zero point calibration of the total load value calculation portion 4b, the load value WF, the load value WR, and the total load value WA will be explained. When the zero point calibration is performed, a part of weight of the seat 9 acts on the first and second load sensors 2F, 2R in a reference state where the vehicle C is not inclined or tilted and any load applying body is not provided on the seat 9. A level of the electric outputs EL, ER in those circumstances is adjusted to be zero. Alternatively, constants of conversion equation of the total load value calculation portion 4b may be determined so that the load values WF, WR are assumed to be zero while the electric outputs EL, ER are not assumed to be zero. By performing the zero point calibration, the load value WF, the load value WR and the total load value WA assume to correspond to a weight of the load applying body per se excluding the weight of the seat 9.

The vehicle-turning-movement determination portion 4d determines that the vehicle C is in the turning movement in a case where the detected lateral acceleration Gy is greater than a preset value after the vehicle motion determination portion 4a determines that the vehicle C is in motion. The vehicle-turning-movement determination portion 4d determines that the vehicle C is in steady motion in a case where the detected lateral acceleration Gy is equal to or lower than the preset value. According to the embodiment, for example, in a case where the lateral acceleration Gy in the right-left direction of the vehicle C exceeds a preset acceleration Gymin, the vehicle-turning-movement determination portion 4d determines that the vehicle C is turning left or right, that is, the vehicle C is in the turning movement.

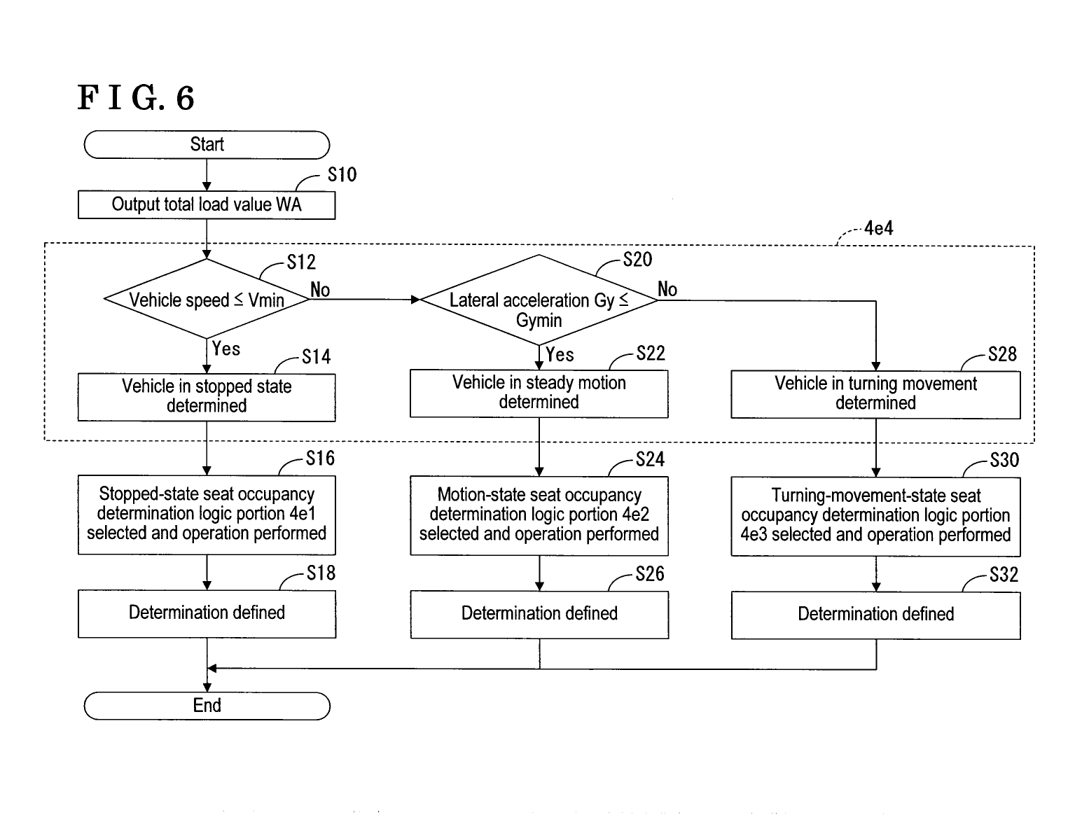

As described above, the seat occupancy determination logic portion 4e includes the logic selection portion 4e4 (see FIGS. 2 and 6), the preset stopped-state seat occupancy determination logic portion 4e1, the preset motion-state seat occupancy determination logic portion 4e2, the preset turning-movement-state seat occupancy determination logic portion 4e3, and the state determination portion 4e5.

The stopped-state seat occupancy determination logic portion 4e1 is a logic portion for the stopping state of the vehicle C applicable when the vehicle motion determination portion 4a determines that the vehicle C is in the stopped state. The motion-state seat occupancy determination logic portion 4e2 is a logic portion for the steady motion state (i.e., serving as the motion-state) of the vehicle C applicable when the vehicle-turning-movement determination portion 4d determines that the vehicle C does not perform the turning movement, that is, the vehicle C is in the steady motion after the vehicle motion determination portion 4a determines that the vehicle C is in motion. The turning-movement-state seat occupancy determination logic portion 4e3 is a logic portion for the turning-movement state of the vehicle C applicable when the vehicle-turning-movement determination portion 4d determines that the vehicle C is in the turning movement after the vehicle motion determination portion 4a determines that the vehicle C is in motion.

Each of the stopped state seat occupancy determination logic portion 4e1, the motion-state seat occupancy determination logic portion 4e2 and the turning-movement-state seat occupancy determination logic portion 4e3 transitions a determination of a current state of the seat 9 to one of a state where the child safety seat is fixed or a child-safety-seat fixed state, a state where an adult passenger is seated or an adult-passenger seated state, and a state where the seat 9 is unoccupied, or a no passenger state. The child-safety-seat fixed state corresponds to a state where the child safety seat is fixed to the seat 9 by the seatbelt. The adult-passenger seated state corresponds to the state where an adult passenger is seated in the seat 9. According to the embodiment, an adult passenger is classified by a male adult and a female adult. The no passenger state corresponds to a state where no passenger is seated in the seat 9, or an infant or a child is seated in the seat 9. Hereinafter, the child-safety-seat fixed state, the adult-passenger seated state, and the no passenger state may be referred to as three states. The adult passenger seated state may be classified by a state where a male adult is seated in the seat 9 (the state is referred to as AM50) and where a female adult is seated in the seat 9 (the state is referred to as AF05). The child-safety-seat fixed state, AM50, AF05, and the no passenger state may be referred to as four states.

As described above, the state where no passenger is seated in the seat 9, or an infant or a child is seated in the seat 9 is referred to as the no passenger state. The state where a male adult is seated in the seat 9 is referred to as AM50. The state where a female adult is seated in the seat 9 is referred to as AF05. The state where the child safety seat is fixed to the seat 9 is referred to as the child-safety-seat fixed state. As described above, according to the disclosure, AM50 and AF05 correspond to the states where an adult passenger is seated in the seat 9.

The current state of the seat 9 which corresponds to the child-safety-seat fixed state, AM50 (the state where an adult passenger is seated), AF05 (the state where an adult passenger is seated) or the no passenger state is referred to as a first state and a state other than the first state is referred to as a second state. Each of the stopped state seat occupancy determination logic portion 4e1, the motion-state seat occupancy determination logic portion 4e2 and the turning-movement-state seat occupancy determination logic portion 4e3 corresponds to a logic which transmits the state of the seat 9 when a preset transition condition from the first state to the second state is satisfied. The availability of transition and the transition conditions from the first state to the second state of the three states are set to be different from each other. That is, in order to determine the transition from the first state to the second state of the three states precisely, each of the stopped-state seat occupancy determination logic portion 4e1, the motion-state seat occupancy determination logic portion 4e2, and the turning-movement-state seat occupancy determination logic portion 4e3 is set with the availability of transition from the first state to the second state of the three states and the transition conditions applicable when the vehicle C is in the stopped state, in motion, and in the turning movement, respectively.

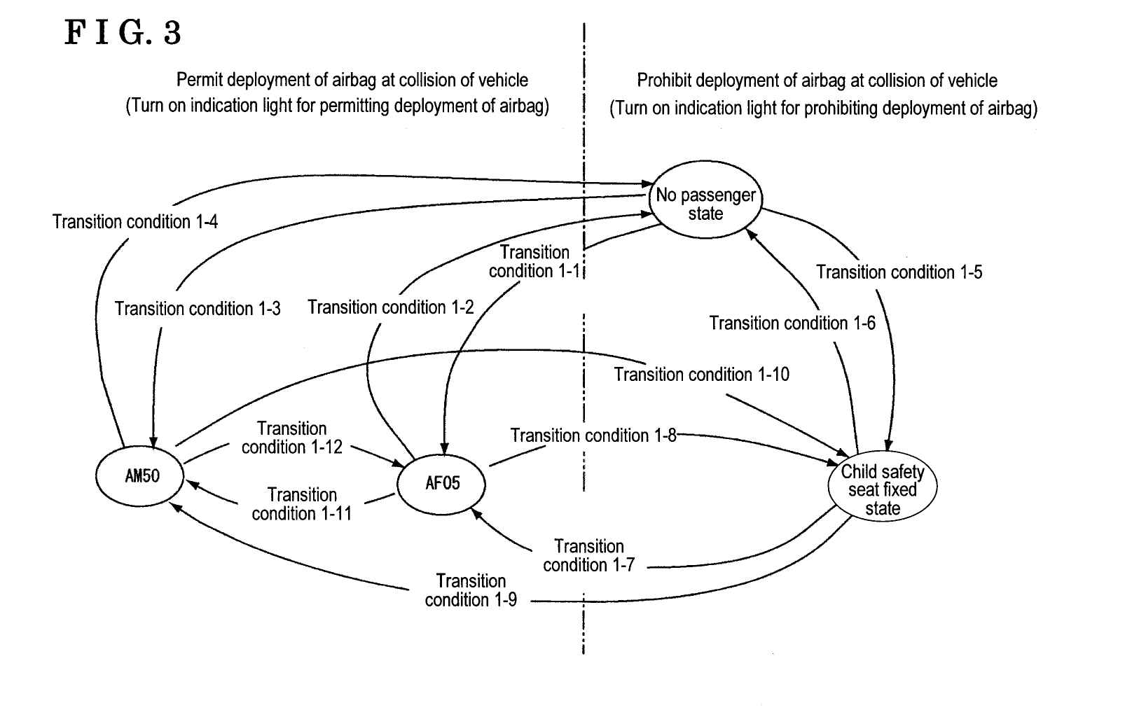

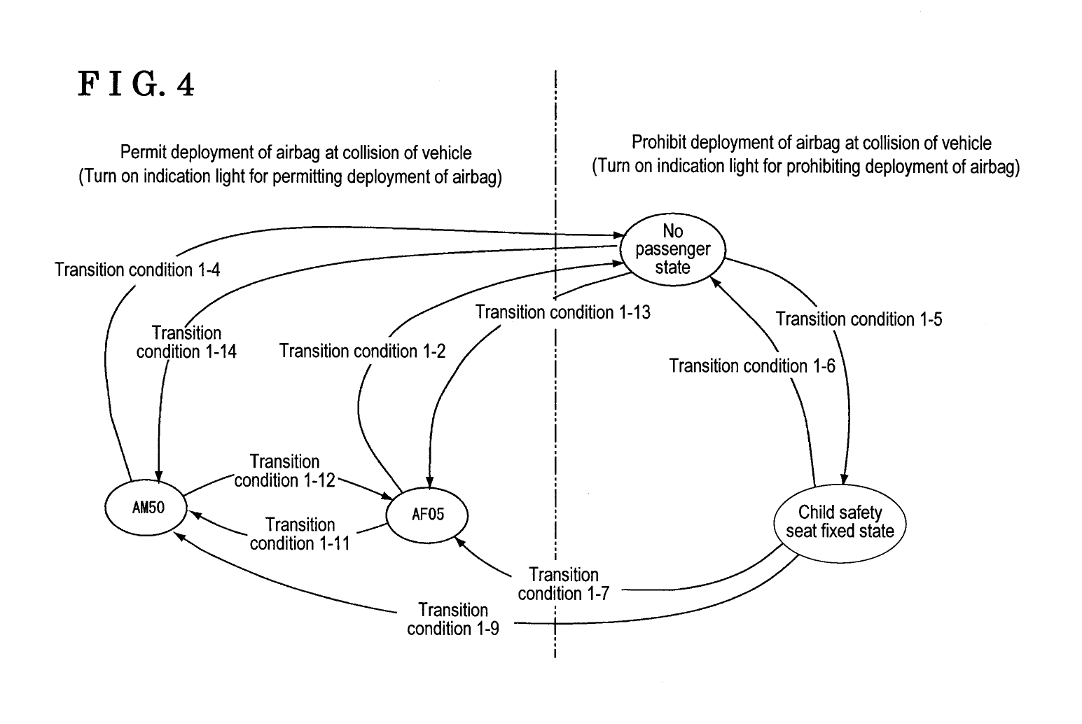

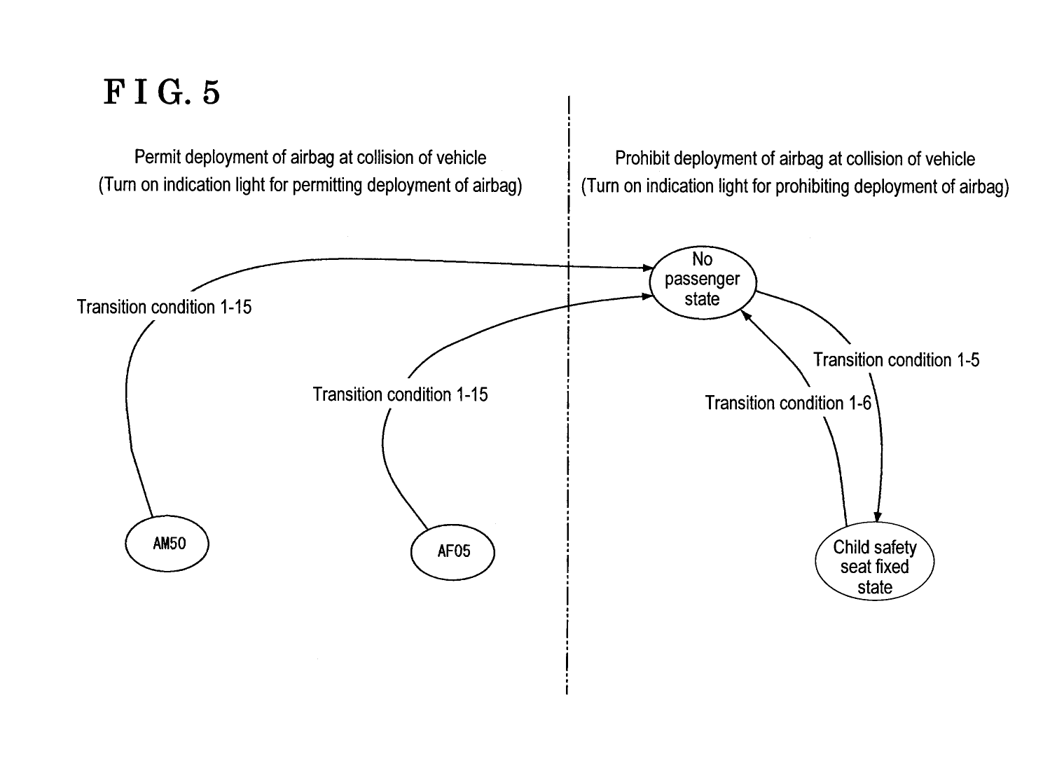

Specifically, according to the embodiment, the stopped-state seat occupancy determination logic portion 4e1 corresponds to a logic portion which transitions the determination of the state of the seat 9 as shown in a transition diagram in FIG. 3. The motion-state seat occupancy determination logic portion 4e2 corresponds to a logic portion which transitions the determination of the state of the seat 9 as shown in a transition diagram in FIG. 4. The turning-movement-state seat occupancy determination logic portion 4e3 corresponds to a logic portion which transitions the determination of the state of the seat 9 as shown in a transition diagram in FIG. 5.

The preset transition condition corresponds to a condition which includes load information, for example, the load value and a load variation detected by the first and second load sensors 2F, 2R and circumferential information of, for example, an attachment of the seatbelt as a parameter. For example, the existence or a physical constitution of an occupant is determined on the basis of the load value and the variation trend of the load value, and the transition condition is set to transition the determination of the state of the seat 9. For example, the existences of an occupant and the child safety seat are determined by the information of the attachment of the seatbelt and the transition condition is set to transition the determination of the state of the seat 9.

The seat occupancy determination logic portion 4e refers to one of the stopped state seat occupancy determination logic portion 4e1, the motion-state seat occupancy determination logic portion 4e2 and the turning-movement-state seat occupancy determination logic portion 4e3 in accordance with the state of the vehicle C and transitions the determination of the current state of the seat 9 between the first state and the second state on the basis of the satisfaction of the transition condition.

According to the embodiment, in order to determine the transition from the first state to the second state of the four states precisely, the stopped-state seat occupancy determination logic portion 4e1 is set with the availability of transition and the transition conditions from the first state to the second state of the three states applicable when the vehicle C is in the stopped state. The motion-state seat occupancy determination logic portion 4e2 is set with the availability of transition from the first state to the second state of the three states and the transition conditions applicable when the vehicle C is in steady motion. The turning-movement-state seat occupancy determination logic portion 4e3 is set and combined with the availability of transition from the first state to the second state of the three states and the transition conditions applicable when the vehicle C is in the turning movement.

Next, schematic diagrams of FIGS. 3 to 5 specifically show the states for transition and the transition conditions for transitioning the determination of the state of the seat 9 between each of the states that the stopped state seat occupancy determination logic portion 4e1, the motion-state seat occupancy determination logic portion 4e2 and the turning-movement-state seat occupancy determination logic portion 4e3 transition. As described above, FIGS. 3 to 5 are referred to as the transition diagrams of the stopped state seat occupancy determination logic portion 4e1, the motion-state seat occupancy determination logic portion 4e2 and the turning-movement-state seat occupancy determination logic portion 4e3, respectively.

FIG. 3 shows the transition diagram of the stopped-state seat occupancy determination logic portion 4e1. As shown in FIG. 3, the stopped-state seat occupancy determination logic portion 4e1 transitions the determination of the state of the seat 9 from the first state to the second state of the four states on the basis of the satisfaction of the transition conditions between a transition condition 1-1 and a transition condition 1-12. Each of the transition conditions 1-1 to 1-12 is set as an individual transition condition, and for example, an individual load value required to satisfy the transition condition may be set, or an individual parameter may be set as the transition condition. Similarly, each of transition conditions 1-13 to 1-15 in FIGS. 4 and 5 is set as the individual transition condition, and for example, the individual load value required to satisfy the transition condition may be set, or the individual parameter may be set as the transition condition.

As shown in FIG. 3, when the stopped-state seat occupancy determination logic portion 4e1 determines that the seat 9 is either in the no passenger state or in the child seat fixed state, the deployment of the airbag is prohibited in the case of the vehicle collision. When the stopped-state seat occupancy determination logic portion 4e1 determines that the seat 9 is either in AM50 or in AF05, the deployment of the airbag is permitted in the case of the vehicle collision.

That is, an airbag control portion determines the state of the seat 9 and outputs an airbag control signal upon receiving the transition result of the state of the seat 9 outputted by the stopped-state seat occupancy determination logic portion 4e1. Similarly, the airbag control portion determines the state of the seat 9 and outputs the airbag control signal upon receiving the transition result of the state of the seat 9 outputted by the motion-state seat occupancy determination logic portion 4e2 and the turning-movement-state seat occupancy determination logic portion 4e3.

In FIG. 3, the stopped-state seat occupancy determination logic portion 4e1 can transit the state of the seat 9 between each of the states which are the no passenger state, AM50, AF05, and the child-safety-seat fixed state. The transition condition between each of the states will be explained with reference to FIG. 3.

First, a transition in a case where the no passenger state corresponds to the first state and AF05 corresponds to the second state will be explained. The transition condition 1-1 is required to be satisfied for the transition from the no passenger state to AF05. That is, the seat occupancy determined state is transitioned from the no passenger state to AF05 when the transition condition 1-1 is satisfied (condition satisfaction).

Next, a transition condition from AF05 to the no passenger state will be explained. In those circumstances, AF05 corresponds to the first state and the no passenger state corresponds to the second state. A transition condition 1-2 is required to be satisfied for the transition from AF05 to the no passenger state. The seat occupancy determined state is transitioned from AF05 to the no passenger state when the transition condition 1-2 is satisfied.

Next, a transition condition between the no passenger state and AM50 will be explained. In those circumstances, the no passenger state corresponds to the first state and AM50 corresponds to the second state. According to the embodiment, a transition condition 1-3 from the no passenger state to AM50 is partially different from the transition condition 1-1 from the no passenger state to AF05. Specifically, the transition condition 1-3 is set with a parameter of the load value greater than a parameter of the load value of the transition condition 1-1. For example, in a case where the load value applied to the seat 9 is required to be equal to or greater than the load value L1 as a required condition to satisfy the transition condition 1-1, the load value applied to the seat 9 is required to be equal to or greater than the load value L2 (which is greater than L1) as a required condition to satisfy the transition condition 1-3.

According to the embodiment, a transition condition 1-4 from AM50 to the no passenger state is set to include the same condition as the transition condition 1-2 from AF05 to the no passenger state.

Next, a transition condition between the no passenger state and the child-safety-seat fixed state will be explained. A transition condition 1-5 is required to be satisfied for the transition from the no passenger state (the first state) to the child-safety-seat fixed state (the second state). The seat occupancy determined state is transitioned from the no passenger state to the child-safety-seat fixed state when the transition condition 1-5 is satisfied.

Next, a transition condition 1-6 is required to be satisfied for the transition from child-safety-seat fixed state (the first state) to the no passenger state (the second state). The seat occupancy determined state is transitioned from the child-safety-seat fixed state to the no passenger state when the transition condition 1-6 is satisfied (condition satisfaction).

Next, a transition condition between the child-safety-seat fixed state and AF05 will be explained. A transition condition 1-7 is required to be satisfied for the transition from the child-safety-seat fixed state (the first state) to AF05 (the second state). The seat occupancy determined state is transitioned from the child-safety-seat fixed state to AF05 when the transition condition 1-7 is satisfied (condition satisfaction).

A transition condition 1-8 is required to be satisfied for the transition from AF05 (the first state) to the child-safety-seat fixed state (the second state). The seat occupancy determined state is transitioned from AF05 to the child-safety-seat fixed state when the transition condition 1-8 is satisfied (condition satisfaction).

Next, a transition condition between the child-safety-seat fixed state and AM50 will be explained. A transition condition 1-9 is required to be satisfied for the transition from the child-safety-seat fixed state (the first state) to AM50 (the second state). The seat occupancy determined state is transitioned from the child-safety-seat fixed state to AM50 when the transition condition 1-9 is satisfied (condition satisfaction).

According to the embodiment, a transition condition 1-9 from the child-safety-seat fixed state to AM50 is partially different from the transition condition 1-7 from the child-safety-seat fixed state to AF05. Specifically, the transition condition 1-9 is set with a parameter of the load value greater than a parameter of the load value of the transition condition 1-7. For example, in a case where the load value applied to the seat 9 is required to be equal to or greater than the load value L3 as a required condition to satisfy the transition condition 1-7, the load value applied to the seat 9 is required to be equal to or greater than the load value L4 (which is greater than L3) as a required condition to satisfy the transition condition 1-9.

A transition condition 1-10 is required to be satisfied for the transition from AM50 (the first state) to the child-safety-seat fixed state (the second state). The seat occupancy determined state is transitioned from AM50 to the child-safety-seat fixed state when the transition condition 1-10 is satisfied (condition satisfaction). According to the embodiment, the transition condition 1-10 from AM50 to the child-safety-seat fixed state is set to include the same condition as the transition condition 1-8 from AF05 to the child-safety-seat fixed state.

A transition condition between AF05 and AM50 will be explained. The transition between AF05 and AM50 is provided for controlling power to deploy the airbag in accordance with the weight of a passenger. A transition condition 1-11 is required to be satisfied for the transition from AF05 (the first state) to AM50 (the second state). The seat occupancy determined state is transitioned from AF05 to AM50 when the transition condition 1-11 is satisfied (condition satisfaction).

Next, a transition condition 1-12 is required to be satisfied for the transition from AM50 (the first state) to AF05 (the second state). The seat occupancy determined state is transitioned from AM50 to AF05 when the transition condition 1-12 is satisfied (condition satisfaction).

As described above, the stopped-state seat occupancy determination logic portion 4e1 applicable when the vehicle C is in the stopped state can always transition the determination of the state of the seat 9 between each of the states of the no passenger state, AM50, AF05, and the child-safety-seat fixed state. As described above, the stopped state seat occupancy determination logic portion 4e1 prohibits the deployment of the airbag and turns on an indication light for prohibition at the collision of the vehicle C in a state where the seat 9 is either in the no passenger state or the child-safety-seat fixed state. When the seat 9 is in AM50 or AF05, the deployment of the airbag is permitted and the indication light for permission is turned on at the collision of the vehicle C in a state where the seat 9 is either in AM50 or AF05.

Next, the operation of the motion-state seat occupancy determination logic portion 4e2 which corresponds to the determination logic portion when the vehicle C is in the steady motion and which is provided at the seat occupancy determination logic portion 4e will be explained with reference to FIG. 4. The motion-state seat occupancy determination logic portion 4e2 determines, for example, the occupancy state on the seat 9 of the vehicle C that a driver mainly performs a straight forward motion without turning the steering wheel. Then, the motion-state seat occupancy determination logic portion 4e2 transitions the determination of the state of the seat 9. In those circumstances, the vehicle C is so-called in steady motion in which the vehicle speed V of the vehicle C exceeds the low vehicle speed Vmin and the lateral acceleration Gy is equal to or lower than a predetermined lateral acceleration Gymin (i.e., serving as a predetermined value). The motion-state seat occupancy determination logic portion 4e2, in the same way as the stopped-state seat occupancy determination logic portion 4e1, can transition the determination of the state of the seat 9 between each of the states of the no passenger state, AM50, AF05, and the child-safety-seat fixed state.

However, the motion-state seat occupancy determination logic portion 4e2 does not include the transition condition 1-10 from AM50 which is one of the adult-passenger seated states to the child-safety-seat fixed state, and the transition condition 1-8 from AF05 which is one of the adult-passenger seated states to the child-safety-seat fixed state. That is, because the motion-state seat occupancy determination logic portion 4e2 corresponds to an operation portion which performs the operation when the vehicle C is in motion, an occupant is not assumed to fix a child safety seat while the vehicle C is in motion. Accordingly, the motion-state seat occupancy determination logic portion 4e2 does not include the transition conditions 1-10 and 1-8.

The motion-state seat occupancy determination logic portion 4e2 is set with the transition condition 1-13 from the no passenger state (the first state) to AF05 (the second state) instead of the transition condition 1-1. That is, the seat occupancy determined state is transitioned from the no passenger state to AF05 when the transition condition 1-13 which is configured with a different parameter from a parameter of the transition condition 1-1 is satisfied. In those circumstances, the transition condition 1-13 corresponds to a condition which is more difficult to be satisfied than the transition condition 1-1. Accordingly, the reliability for transition is enhanced. The transition condition from AF05 to the no passenger state is the same as the transition condition 1-2 from AF05 to the no passenger state being set in the stopped-state seat occupancy determination logic portion 4e1 and will not be explained.

Next, the transition condition between the no passenger state and AM50 will be explained. The motion-state seat occupancy determination logic portion 4e2 is set with a transition condition 1-14 from the no passenger state (the first state) to AM50 (the second state) instead of the transition condition 1-3. The transition condition 1-14, in the same way as the transition condition 1-13 which is more difficult to be satisfied than the transition condition 1-1, corresponds to a condition which is more difficult to be satisfied than the transition condition 1-3. Accordingly, in the same way as the transition condition 1-13, the reliability for transition is enhanced. The seat occupancy determined state is transitioned from the no passenger state to AM50 when the transition condition 1-14 which is configured with a parameter which is more difficult to be satisfied than the transition condition 1-3. The transition condition from AM50 to the no passenger state is the same as the transition condition 1-4 from AM50 to the no passenger state being set in the stopped-state seat occupancy determination logic portion 4e1 and will not be explained.

In addition to the above-explained transition, the transition conditions excluding the transition conditions 1-8 and 1-10 of the transition conditions of 1-5 to 1-12 that are included by the stopped-state seat occupancy determination logic portion 4e1 and the motion-state seat occupancy determination logic portion 4e2 are the same as the transition conditions included by the stopped-state seat occupancy determination logic portion 4e1 and the motion-state seat occupancy determination logic portion 4e2 and will not be explained.

Next, the operation of the turning-movement-state seat occupancy determination logic portion 4e3 which corresponds to the determination logic portion when the vehicle C is in the turning movement and which is provided at the seat occupancy determination logic portion 4e will be explained with reference to FIG. 5. The turning-movement-state seat occupancy determination logic portion 4e3 determines the occupancy state of the seat 9 of the vehicle C that a driver mainly performs the turning movement by turning the steering wheel at a predetermined angle. Then, the turning-movement-state seat occupancy determination logic portion 4e3 transitions the determination of the state of the seat 9. In those circumstances, the vehicle C performs the turning movement in which the vehicle speed V of the vehicle C exceeds the low vehicle speed Vmin and the lateral acceleration Gy exceeds the predetermined lateral acceleration Gymin.

As shown in FIG. 5, the turning-movement-state seat occupancy determination logic portion 4e3 can transition the determination of the state of the seat 9 only between the no passenger state and AF05, between the no passenger state and AM50, and between the no passenger state and child safety seat fixed state unlike the stopped-state seat occupancy determination logic portion 4e1 and the motion-state seat occupancy determination logic portion 4e2. The turning-movement-state seat occupancy determination logic portion 4e3, in the same way as the motion-state seat occupancy determination logic portion 4e2, does not include the transition conditions 1-8 and 1-10 because an occupant is not assumed to fix a child safety seat while the vehicle C is in motion (or in the turning movement).

Further, the turning-movement-state seat occupancy determination logic portion 4e3 does not include the transition conditions 1-1, 1-3, 1-13, 1-14 because an adult passenger is not assumed to be seated in the seat 9 which is determined as the no passenger state while the vehicle C is in the turning movement. Further, the turning-movement-state seat occupancy determination logic portion 4e3 does not include the transition conditions 1-7 and 1-9 because the state of the seat 9 is not assumed to be transitioned between the child-safety-seat fixed state and AM50 and between the child-safety-seat fixed state and AF05 while the vehicle C is in the turning movement. Further, the turning-movement-state seat occupancy determination logic portion 4e3 does not include the transition conditions 1-11 and 1-12 because the state of the seat 9 is not assumed to be transitioned between AM50 and AF05 while the vehicle C is in the turning movement.

The turning-movement-state seat occupancy determination logic portion 4e3 is set with the same transition condition between the no passenger state and the child-safety-seat fixed state as the transition conditions of the stopped-state seat occupancy determination logic portion 4e1 and the motion-state seat occupancy determination logic portion 4e2, which are the transition conditions 1-5 and 1-6. Regarding the transition between the no passenger state and AF05 and the transition between the no passenger state and AM50, the transition only from AF05 (the first state) to the no passenger state (the second state) and the transition only from AM50 (the first state) to the no passenger state (the second state) are set.

A transition condition 1-15 is required to be satisfied for the transition from AF05 (the first state) to the no passenger state (the second state). The seat occupancy determined state is transitioned from AF05 to the no passenger state when the transition condition 1-15 is satisfied (condition satisfaction). In those circumstances, the transition condition 1-15 corresponds to a condition which is more difficult to be satisfied than the transition condition 1-2 from AF05 to the no passenger state being set in the stopped-state seat occupancy determination logic portion 4e1 and the motion-state seat occupancy determination logic portion 4e2. Accordingly, the reliability for transition is enhanced.

The seat occupancy determined state is transitioned from AM50 to the no passenger state when the transition condition 1-15 is satisfied (condition satisfaction) in the same way as the transition from AF05 (the first state) to the no passenger state (the second state). In those circumstances, the transition condition 1-15 corresponds to a condition which is more difficult to be satisfied than the transition condition 1-4 from AM50 to the no passenger state being set in the stopped-state seat occupancy determination logic portion 4e1 and the motion-state seat occupancy determination logic portion 4e2. Accordingly, the reliability for transition is enhanced.

Next, the operation of the seat occupancy determination device 1 according to the embodiment will be explained referring to a flowchart of the seat occupancy determination logic portion 4e shown in FIG. 6 and the transition diagrams shown in FIGS. 3 to 5. According to the flowchart, the ECU 4 starts operation when an ignition switch is turned on or the buckle information BSW is turned on when a driver wears the seatbelt. Then, in step S10, the first and second load sensors 2F, 2R output the electric outputs EF, ER, respectively, and the total load value calculation portion 4b calculates the electrical outputs EL, ER detected at the predetermined sampling cycle using a predetermined conversion equation and outputs the total load value WA.

In step S12, the vehicle-motion determination portion 4a determines whether the vehicle C is in motion or in the stopped state on the basis of the vehicle speed V outputted by the vehicle speed sensor 6. As described above, in a case where the vehicle speed V exceeds the low vehicle speed Vmin, the program proceeds to step S20. In a case where the vehicle speed V is equal to or lower than the low vehicle speed Vmin, the program proceeds to step S14 and determines that the vehicle C is in the stopped state.

After it is determined that the vehicle C is in the stopped state in step S14, the program proceeds to step S16. In step S16, the logic selection portion 4e4 of the seat occupancy determination logic portion 4e selects the stopped-state seat occupancy determination logic portion 4e1 which starts the transition of the state of the seat 9. The stopped-state seat occupancy determination logic portion 4e1 corresponds to the seat occupancy determination logic portion when the vehicle C is in the stopped state and is set with the transition conditions which are combined and set to be applicable when the vehicle C is in the stopped state.

In step S16, the stopped-state seat occupancy determination portion 4e1 determines that the seat 9 is, for example, in the no passenger state as a default setting. At the same time, the total load value WA outputted from the total load value calculation portion 4b and the buckle information BSW are obtained at predetermined sampling cycle (see FIG. 2). In a case where the no passenger state is regarded as the first state, the stopped-state seat occupancy determination portion 4e1 determines whether each of the transition conditions between the no passenger state and the child-safety-seat fixed state which serves as the second state, between the no passenger state and AM50 which serves as the second state, and between the no passenger state and AF05 which serves as the second state is satisfied.

For example, in a case where the transition condition 1-1 from the no passenger state to AF05 is satisfied, the stopped-state seat occupancy determination portion 4e1 transitions the determination of the current state of the seat 9 from the no passenger state which is tentatively set as the default setting to AF05. The stopped-state seat occupancy determination portion 4e1 transitions the determination of the state of the seat 9 from the no passenger state to the child-safety-seat fixed state and from the no passenger state to AM50 as long as each of the transition conditions is satisfied.

In step S18, the state determination portion 4e5 determines that the current state of the seat 9 is AF05 which corresponds to the state where a female adult is seated in the seat 9. The determination result is immediately sent to the airbag control portion which outputs the airbag control signal S. The deployment of the airbag A at the collision of the vehicle C is permitted and the indication light for permission is turned on by the airbag control signal S.

According to the above explanation, in a state where the transition conditions from the no passenger state (the first state) to other states (the second state) are not satisfied, the state determination portion 4e5 determines that the seat 9 is in the no passenger state in step S18. In those circumstances, the determination result is sent to the airbag control portion which outputs the airbag control signal S. The deployment of the airbag A at the collision of the vehicle C is prohibited and the indication light for prohibition is turned on by the airbag control signal S.

In step C20, the vehicle-turning-movement determination portion 4d determines whether the vehicle C is in steady motion or is in the turning movement in response to the obtained lateral acceleration Gy. In a case where the lateral acceleration Gy is equal to or lower than the predetermined value of the predetermined lateral acceleration Gymin, the program proceeds to step S22 and determines that the vehicle C is in steady motion. In a case where the lateral acceleration Gy exceeds the predetermined lateral acceleration Gymin, the program proceeds to step S28 and determines that the vehicle C is in the turning movement.

When it is determined that the vehicle C is in steady motion in step S22, the program proceeds to step S24 and the logic selection portion 4e4 of the seat occupancy determination logic portion 4e selects the motion-state seat occupancy determination logic portion 4e2 which starts the determination. The motion-state seat occupancy determination logic portion 4e2 corresponds to the seat occupancy determination logic portion when the vehicle C is in motion and is set with the transition conditions which are combined and set to be applicable when the vehicle C is in motion.

In step S24, the motion-state seat occupancy determination logic portion 4e2 determines that the seat 9 is, for example, in the no passenger state as the default setting. At the same time, in the same way as step S16, the total load value WA outputted from the total load value calculation portion 4b and the buckle information BSW are obtained at predetermined sampling cycle. In a case where the no passenger state is regarded as the first state, the motion-state seat occupancy determination logic portion 4e2 determines whether the transition conditions between the no passenger state and the child-safety-seat fixed state which serves as the second state, between the no passenger state and AM50 which serves as the second state, and the no passenger state and AF05 which serve as the second states is satisfied.

For example, in a case where the transition condition 1-13 from the no passenger state to AF05 is satisfied, the motion-state seat occupancy determination logic portion 4e2 transitions the determination of the current state of the seat 9 from the no passenger state which is tentatively set as the default setting to AF05. The motion-state seat occupancy determination logic portion 4e2 transitions the determination of the state of the seat 9 from the no passenger state to the child-safety-seat fixed state and from no passenger state to AM50 as long as each of the transition conditions is satisfied.

In step S26, the state determination portion 4e5 determines that the current state of the seat 9 is AF05 which corresponds to the state where a female adult is seated in the seat 9. The determination result is immediately sent to the airbag control portion which outputs the airbag control signal S. The deployment of the airbag A at the collision of the vehicle C is permitted and the indication light for permission is turned on by the airbag control signal S.

Next, in step S28, it is determined that the vehicle C is in the turning movement. When the vehicle C is in the turning movement in step S28, the program proceeds to step S30 and the logic selection portion 4e4 of the seat occupancy determination logic portion 4e selects the turning-movement-state seat occupancy determination logic portion 4e3 which starts the determination. The turning-movement-state seat occupancy determination logic portion 4e3 corresponds to the seat occupancy determination logic portion when the vehicle C is in the turning movement and is set with the transition conditions which are combined and set to be applicable when the vehicle C is in the turning movement.

In step S30, the turning-movement-state seat occupancy determination logic portion 4e3 determines that the seat 9 is, for example, in the no passenger state as the default setting. At the same time, in the same way as steps S16 and S24, the total load value WA outputted from the total load value calculation portion 4b and the buckle information BSW are obtained at predetermined sampling cycle. In a case where the no passenger state is regarded as the first state, the turning-movement-state seat occupancy determination logic portion 4e3 determines whether the transition condition 1-5 from the no passenger state to the child-safety-seat fixed state which serves as the second state is satisfied. In a case where the transition condition 1-5 from the no passenger state to the child-safety-seat fixed state is satisfied by satisfying the transition condition, the turning-movement-state seat occupancy determination logic portion 4e3 transitions the determination of the current state of the seat 9 from the no passenger state which is tentatively set as the default setting to the child-safety-seat fixed state.

In step S32, the state determination portion 4e5 determines that the current state of the seat 9 is in the child-safety-seat fixed state. The determination result is immediately sent to the airbag control portion which outputs the airbag control signal S. The deployment of the airbag A at the collision of the vehicle C is prohibited and the indication light for prohibition is turned on by the airbag control signal S.

As described above, steps S12, S14, S20, S22 and S28 are performed by the logic selection portion 4e4 of the seat occupancy determination logic portion 4e. Steps S18, S26 and S32 are performed by the status determination portion.

As explained above, the transition of each of the stopped-state seat occupancy determination logic portion 4e1, the motion-state seat occupancy determination logic portion 4e2, and the turning-movement-state seat occupancy determination logic portion 4e3 performed in steps S16, S24, S30, respectively, starts from the no passenger state as the default setting, however is not limited to this. For example, in a case where the state determination portion 4e5 determines that the state of the seat 9 is AF05 in step S18 on the basis of the operation of the stopped-state seat occupancy determination logic portion 4e1 at an initial operation after the ignition is turned on, AF05 is stored in the memory portion. Thus, in a case where the program proceeds step S10 again and reaches either step S24 or step S30 via step S12 or step S20, the transition from stored AF05 which serves as an initial state to the second state is performed.

However, in a case where the transition condition from the initial state stored in the memory portion to the second state is not satisfied, the transition is not performed and the state before transition, that is, the first state corresponds to the current state. Accordingly, as shown in the flowchart in FIG. 6, one of the stopped-state seat occupancy determination logic portion 4e1, the motion-state seat occupancy determination logic portion 4e2, and the turning-movement-state seat occupancy determination logic portion 4e3 always defines the current state of the seat 9 in a state where the ignition is in an on state. Similarly, other transitions may be repeated by storing the initial state in the memory portion and the transition from the initial state to the second state is performed.

According to the aforementioned embodiment, following effects and advantages may be attained. As is clear from the above-described explanation, according to the embodiment, in a case where the determination of the state of the seat 9 is performed using the transition condition other than the transition conditions when the vehicle C is in the stopped state or in the motion-state, the turning-movement-state seat occupancy determination logic portion 4e3 is provided individually from the stopped-state seat occupancy determination logic portion 4e1 and the motion-state seat occupancy determination logic portion 4e2. Accordingly, the load of the control may be largely decreased, which contributes to the cost reduction comparing to a case where the transition conditions are rewritten on the program for determination.

According to the embodiment, in a case where the vehicle C is in the turning movement, the state of the seat 9 may be precisely determined whether the seat 9 is seated by an adult passenger, whether the seat 9 is fixed by the child safety seat, or whether the seat 9 is unoccupied on the basis of the transition condition being set to precisely transition the determination of the state of the seat 9 between the child-safety-seat fixed state, the adult-passenger seated state, and the no passenger state when the vehicle C is in the turning movement. Comparing to the known seat occupancy determination device which stops the determination of the state of the seat when the vehicle C is in the turning movement, the performance of the seat occupancy determination device 1 of this disclosure is enhanced.

According to the embodiment, because the lateral acceleration detection portion corresponds to the G sensor 5 (the acceleration sensor), the G sensor 5 may also be used as an acceleration sensor which is normally provided at the vehicle C, and thus the cost reduction is achieved.

According to the aforementioned embodiment, the seat occupancy determination logic portion 4e of the seat occupancy determination device 1 includes the stopped-state seat occupancy determination logic portion 4e1, the motion-state seat occupancy determination logic portion 4e2, and the turning-movement-state seat occupancy determination logic portion 4e3 which accord with the three states of the vehicle C. The logic selection portion 4e4 selects one of the stopped-state seat occupancy determination logic portion 4e1, the motion-state seat occupancy determination logic portion 4e2, and the turning-movement-state seat occupancy determination logic portion 4e3 in accordance with the states of the vehicle C and controls the transition of the state of the seat 9.

Alternatively, only stopped-state seat occupancy determination logic portion 4e1 and the motion-state seat occupancy determination logic portion 4e2 may be provided to transition the determination of the state of the seat 9 and determine the occupancy of the seat 9 without the turning-movement-state seat occupancy determination logic portion 4e3. In those circumstances, the preset individual seat occupancy determination logic portion determines the state of the seat 9 when the vehicle C is in the stopped state or in motion, which leads to reduce the load of the control. That is, comparing to a case where the determination of the state of the seat 9 is performed by inputting (rewriting) the transition condition for determination everytime the vehicle C is in the stopped state or in motion, the load of the control may be reduced, which contributes to the cost reduction.

According to the aforementioned embodiment, the buckle information BSW and the total load value WA which are explained as elements of the transition condition are examples. The transition condition may be set with any contents and any combinations. For example, the acceleration and the speed of the vehicle C may be used as the elements of the transition condition.

According to the aforementioned embodiment, the seat occupancy determination device 1 is provided at the passenger seat which is placed at the right side of a driver's seat. Alternatively, the seat occupancy determination device 1 may be provided at the passenger seat which is placed at the left side of a driver's seat of a right-hand drive vehicle. In such a case, the first and second load sensors 2F, 2R may be placed at the bottom front portion and the bottom rear portion of the right side of the seat, the side where the buckle is provided. Similar effects as the aforementioned embodiment may be obtained. Alternatively, the first and second load sensors 2F, 2R may be placed at the bottom front portion and the bottom rear portion of the side which is opposite to the side where the buckle is provided. Reasonable effects may be obtained.

According to the aforementioned embodiment, the seat occupancy determination device 1 includes the first load sensor 2F configured to be placed at the bottom front portion of one of the sides of the vehicle seat (the seat 9) in the vehicle width direction, the first load sensor 2F detecting a part of the load applied to the vehicle seat (the seat 9), the second load sensor 2R configured to be placed at the bottom rear portion of the one of the sides of the vehicle seat (the seat 9), the one of the sides where the first load sensor 2F is placed, the second load sensor 2R placed to be spaced apart from the first load sensor 2F, the second load sensor 2R detecting a part of the load applied to the vehicle seat (the seat 9), the seatbelt attachment detection device (the buckle switch 3) configured to detect the engagement and disengagement of the tongue plate and the buckle of the seatbelt, the total load value calculation portion 4b calculating the total load value WA of the first load value WF detected by the first load sensor 2F and the second load value WR detected by the second load sensor 2R, the vehicle motion determination portion 4a configured to determine whether the vehicle C is in the stopped state or in motion in response to the vehicle speed V detected by the vehicle speed detection portion (the vehicle speed sensor 6), and the seat occupancy determination logic portion 4e configured to determine a state of the vehicle seat (the seat 9) whether the vehicle seat (the seat 9) is in the child-safety-seat fixed state which is the state where the child safety seat is fixed on the vehicle seat (the seat 9), in the adult-passenger seated state which is the state where an adult passenger is seated in the vehicle seat (the seat 9), and in the no passenger state which is the state where no passenger is seated, or an infant or a child is seated in the vehicle seat (the seat 9); the seat occupancy determination logic portion 4e transitioning the determination of the current state of the vehicle seat (the seat 9) from the first state to the second state of the three states which are the child-safety-seat fixed state, the adult-passenger seated state, and the no passenger state on the basis of the satisfaction and dissatisfaction of the preset transition condition (1-1, 1-2, 1-3, 1-4, 1-5, 1-6, 1-7, 1-8, 1-9, 1-10, 1-11, 1-12, 1-13, 1-14) from the first state to the second state, the seat occupancy determination logic portion 4e including the stopped-state seat occupancy determination logic portion 4e1 being set with the availability of transition from the first state to the second state of the three states and the transition conditions (1-1, 1-2, 1-3, 1-4, 1-5, 1-6, 1-7, 1-8, 1-9, 1-10, 1-11, 1-12) from the first state to the second state of the three states individually in order to transition the determination of the state of the vehicle seat (the seat 9) precisely between the three states which are the child-safety-seat fixed state, the adult-passenger seated state, and the no passenger state when the vehicle C is in the stopped state, the motion-state seat occupancy determination logic portion 4e2 being set with the availability of transition from the first state to the second state of the three states and the transition conditions (1-2, 1-4, 1-5, 1-6, 1-7, 1-9, 1-11, 1-12, 1-13, 1-14) from the first state to the second state of the three states individually in order to transition the determination of the state of the vehicle seat (the seat 9) precisely between the three states which are the child-safety-seat fixed state, the adult-passenger seated state, and the no passenger state when the vehicle C is in motion, and the logic selection portion 4e4 selecting the stopped-state seat occupancy determination logic portion 4e1 when the vehicle C is in the stopped state, the logic selection portion 4e4 selecting the motion-state seat occupancy determination logic portion 4e2 when the vehicle C is in motion.

According to the aforementioned embodiment, because the preset individual seat occupancy determination logic portion determines the state of the seat 9 when the vehicle C is in the stopped state or in motion, the load of the control may be reduced. That is, comparing to a case where the determination is performed by inputting the availability of transition from the first state to the second state of the three states and the transition conditions for determination, that is, by rewriting each of the conditions, everytime the vehicle C is in the stopped state or in motion, the load of the control may be reduced, which contributes to the cost reduction.

According to the aforementioned embodiment, the motion-state seat occupancy determination logic portion 4e2 does not transition the determination of the state of the vehicle seat (the seat 9) from the adult-passenger seated state to the child-safety-seat fixed state whereas the stopped-state seat occupancy determination logic portion 4e1 transitions the determination of the state of the vehicle seat (the seat 9) from the adult-passenger seated state to the child-safety-seat fixed state, and the motion-state seat occupancy determination logic portion 4e2 is set with the transition condition (1-13, 1-14) from the no passenger state to the adult-passenger seated state, the transition condition (1-13, 1-14) which is more difficult to be satisfied than the transition condition (1-1, 1-3) from the no passenger state to the adult-passenger seated state, the transition condition (1-1, 1-3) being set in the stopped-state seat occupancy determination logic portion 4e1.

According to the aforementioned embodiment, the transition conditions from the adult-passenger seated state to the child-safety-seat fixed state which may not be occurred when the vehicle C is in motion are not provided. In addition, the transition conditions from the no passenger state to the adult-passenger seated state which include low frequency to be occurred when the vehicle C is in motion are difficult to be satisfied. Accordingly, the reasonable and reliable determination of the transition when the vehicle C is in motion may be performed.

According to the aforementioned embodiment, the seat occupancy determination device 1 further includes the lateral acceleration detection portion (G sensor 5) detecting the lateral acceleration Gy applied to the vehicle C, and a vehicle-turning-movement determination portion 4d determining that the vehicle C is in the turning movement in a case where the detected lateral acceleration Gy is greater than the predetermined value Gymin after the vehicle motion determination portion 4a determines that the vehicle C is in motion. The seat occupancy determination logic portion 4e further includes the turning-movement-state seat occupancy determination logic portion 4e3 being set with the availability of transition from the first state to the second state of the three states and the transition conditions (1-5, 1-6, 1-15) from the first state to the second state of the three states individually in order to transition the determination of the state of the vehicle seat (the seat 9) precisely between the three states which are the child-safety-seat fixed state, the adult-passenger seated state, and the no passenger state when the vehicle C is in the turning movement. The logic selection portion 4e4 selects the turning-movement-state seat occupancy determination logic portion 4e3 when the vehicle C is in the turning movement.

According to the aforementioned embodiment, in a case where the vehicle C is in the turning movement, the state of the seat 9 may be precisely determined whether the seat 9 is seated by an adult passenger, whether the seat 9 is fixed by the child safety seat, or whether the seat 9 is unoccupied on the basis of the transition condition being set to precisely transition the determination of the state of the seat 9 between the child-safety-seat fixed state, the adult-passenger seated state, and the no passenger state. Thus, comparing to the known seat occupancy determination device which stops the determination of the state of the seat when the vehicle C is in the turning movement, the performance of the seat occupancy determination device 1 of this disclosure is enhanced. In addition, because the transition condition is preset, the load of the control may be reduced.

According to the aforementioned embodiment, the turning-movement-state seat occupancy determination logic portion 4e3 is set to enable to transition the determination of the state of the vehicle seat (the seat 9) only between the no passenger state and the child-safety-seat fixed state and from the adult-passenger seated state to the no passenger state, the turning-movement-state seat occupancy determination logic portion 4e3 is set with the transition condition (1-15) from the adult-passenger seated state to the no passenger state, the transition condition (1-15) which is more difficult to be satisfied than the transition condition (1-2, 1-4) from the adult-passenger seated state to the no passenger state, the transition condition (1-2, 1-4) being set in the stopped-state seat occupancy determination logic portion 4e1 and the motion-state seat occupancy determination logic portion 4e2.

As described above, the turning-movement-state seat occupancy determination logic portion 4e3 is set to enable the transition of the state of the seat 9 only between the no passenger state and the child-safety-seat fixed state, and from the adult-passenger seated state to the no passenger state, which may be occurred when the vehicle C is in the turning movement. The transition condition from the adult-passenger seated state to the no passenger state when the vehicle C is in the turning operation may be more difficult to be satisfied than the transition condition from the adult-passenger seated state to the no passenger state determined by the stopped-state seat occupancy determination logic portion 4e1 and by the motion-state seat occupancy determination logic portion 4e2. That is, the transition is set to be difficult to be satisfied. Accordingly, when the vehicle C is in the turning movement which may largely vary the load because of the centrifugal force occurred by the turning movement of the vehicle C, the transition from the adult-passenger seated state to the no passenger state may be difficult to be satisfied. Thus, the wrong determination that it is determined that the seat 9 is in the no passenger state even if an adult passenger is seated may be favorably prevented.

According to the aforementioned embodiment, the lateral acceleration detection portion (the G sensor 5) detects the lateral acceleration Gy by an acceleration sensor (the G sensor 5).

In those circumstances, the G sensor 5 may also be used as an acceleration sensor which is normally provided at the vehicle C, and thus the cost reduction is achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat occupancy determination device, comprising:
a first load sensor configured to be placed at a bottom front portion of one of sides of a vehicle seat in a vehicle width direction, the first load sensor detecting a part of a load applied to the vehicle seat;
a second load sensor configured to be placed at a bottom rear portion of the one of the sides of the vehicle seat, the one of the sides where the first load sensor is placed, the second load sensor placed to be spaced apart from the first load sensor, the second load sensor detecting a part of the load applied to the vehicle seat;
a seatbelt attachment detection device configured to detect an engagement and disengagement of a tongue plate and a buckle of a seatbelt;
a total load value calculation portion calculating a total load value of a first load value detected by the first load sensor and a second load value detected by the second load sensor;
a vehicle motion determination portion configured to determine whether a vehicle is in a stopped state or in motion in response to a vehicle speed detected by a vehicle speed detection portion; and
a seat occupancy determination logic portion configured to determine a state of the vehicle seat whether the vehicle seat is in a child-safety-seat fixed state which is a state where a child safety seat is fixed on the vehicle seat, in an adult-passenger seated state which is a state where an adult passenger is seated in the vehicle seat, and in a no passenger state which is a state where no passenger is seated, or an infant or a child is seated in the vehicle seat; the seat occupancy determination logic portion transitioning a determination of a current state of the vehicle seat from a first state to a second state of three states which are the child-safety-seat fixed state, the adult-passenger seated state, and the no passenger state on the basis of a satisfaction and dissatisfaction of a preset transition condition from the first state to the second state;
the seat occupancy determination logic portion including:
a stopped-state seat occupancy determination logic portion being set with an availability of transition from the first state to the second state of the three states and the transition conditions from the first state to the second state of the three states individually in order to transition the determination of the state of the vehicle seat precisely between the three states which are the child-safety-seat fixed state, the adult-passenger seated state, and the no passenger state when the vehicle is in the stopped state;
a motion-state seat occupancy determination logic portion being set with the availability of transition from the first state to the second state of the three states and the transition conditions from the first state to the second state of the three states individually in order to transition the determination of the state of the vehicle seat precisely between the three states which are the child-safety-seat fixed state, the adult-passenger seated state, and the no passenger state when the vehicle is in motion; and
a logic selection portion selecting the stopped-state seat occupancy determination logic portion when the vehicle is in the stopped state, the logic selection portion selecting the motion-state seat occupancy determination logic portion when the vehicle is in motion.

2. The seat occupancy determination device according to claim 1, wherein the motion-state seat occupancy determination logic portion does not transition the determination of the state of the vehicle seat from the adult-passenger seated state to the child-safety-seat fixed state whereas the stopped-state seat occupancy determination logic portion transitions the determination of the state of the vehicle seat from the adult-passenger seated state to the child-safety-seat fixed state, and the motion-state seat occupancy determination logic portion is set with the transition condition from the no passenger state to the adult-passenger seated state, the transition condition which is more difficult to be satisfied than the transition condition from the no passenger state to the adult-passenger seated state, the transition condition being set in the stopped-state seat occupancy determination logic portion.

3. The seat occupancy determination device according to claim 1, further comprising:
a lateral acceleration detection portion detecting a lateral acceleration applied to the vehicle; and
a vehicle-turning-movement determination portion determining that the vehicle is in a turning movement in a case where the detected lateral acceleration is greater than a predetermined value after the vehicle motion determination portion determines that the vehicle is in motion; wherein
the seat occupancy determination logic portion further includes a turning-movement-state seat occupancy determination logic portion being set with the availability of transition from the first state to the second state of the three states and the transition conditions from the first state to the second state of the three states individually in order to transition the determination of the state of the vehicle seat precisely between the three states which are the child-safety-seat fixed state, the adult-passenger seated state, and the no passenger state when the vehicle is in the turning movement; and
the logic selection portion selects the turning-movement-state seat occupancy determination logic portion when the vehicle is in the turning movement.

4. The seat occupancy determination device according to claim 2, further comprising:
a lateral acceleration detection portion detecting a lateral acceleration applied to the vehicle; and
a vehicle-turning-movement determination portion determining that the vehicle is in a turning movement in a case where the detected lateral acceleration is greater than a predetermined value after the vehicle motion determination portion determines that the vehicle is in motion; wherein
the seat occupancy determination logic portion further includes a turning-movement-state seat occupancy determination logic portion being set with the availability of transition from the first state to the second state of the three states and the transition conditions from the first state to the second state of the three states individually in order to transition the determination of the state of the vehicle seat precisely between the three states which are the child-safety-seat fixed state, the adult-passenger seated state, and the no passenger state when the vehicle is in the turning movement; and
the logic selection portion selects the turning-movement-state seat occupancy determination logic portion when the vehicle is in the turning movement.

5. The seat occupancy determination device according to claim 4, wherein the turning-movement-state seat occupancy determination logic portion is set to enable to transition the determination of the state of the vehicle seat only between the no passenger state and the child-safety-seat fixed state and from the adult-passenger seated state to the no passenger state, the turning-movement-state seat occupancy determination logic portion is set with the transition condition from the adult-passenger seated state to the no passenger state, the transition condition which is more difficult to be satisfied than the transition condition from the adult-passenger seated state to the no passenger state, the transition condition being set in the stopped-state seat occupancy determination logic portion and the motion-state seat occupancy determination logic portion.

6. The seat occupancy determination device according to claim 4, wherein the lateral acceleration detection portion detects the lateral acceleration by an acceleration sensor.

7. The seat occupancy determination device according to claim 5, wherein the lateral acceleration detection portion detects the lateral acceleration by an acceleration sensor.
